(19) United States
(12) Patent Application Publication
(10) Pub. No.: US 2017/0224172 A1
(43) Pub. Date: Aug. 10, 2017

(54) Container for Kitchen and Cooking Utensils

(71) Applicant: Hay Finance Group AS, Stavanger (NO)

(72) Inventor: Stein Strømsten, Stavanger (NO)

(73) Assignee: Hay Finance Group AS, Stavanger (NO)

(21) Appl. No.: 15/328,670

(22) PCT Filed: Jul. 30, 2015
(86) PCT No.: PCT/NO2015/050130

§ 371 Date: Jan. 24, 2017

(30) Foreign Application Priority Data
Aug. 1, 2014 (NO) 20140955

(51) Int. Cl. A47J 43/28

(52) U.S. Cl. CPC A47J 43/287

(57) ABSTRACT

A container is for storing kitchen and cooking utensils (in an upright orientation). The container is preferably heat-resistant to enable use on a stove. The container is further configured for establishing, in operational use, a releasable connection between the container and a pan, such as a casserole or pot. The container comprises a releasable coupling for establishing the releasable connection between the container and the pan. The releasable coupling comprises a corner or hook for being hung over an edge of the pan in operational. use.

### FIELD

The invention relates to a container for kitchen and cooking utensils and to a cooking pan assembly comprising such container.

### BACKGROUND

When preparing food on a stove various cooking and kitchen utensils are generally used. Quite often such utensils are temporarily needed to stir the food, flip the food, or take a sample for tasting. After use such utensils are then laid back on the counter.

Quite often it happens that while taking or putting back those utensils food is falling or dripping off from the utensils, thereby making the stove and counter dirty. A similar problem often occurs at the table where it is an ongoing struggle to store the utensil, when it is not used, for instance when food has been taken out of the pan.

### SUMMARY

The invention has for its object to remedy or to reduce at least one of the drawbacks is of the prior art, or at least provide a useful alternative to prior art.

The object is achieved through features, which are specified in the description below and in the claims that follow.

The invention is defined by the independent patent claims. The dependent claims define advantageous embodiments of the invention.

In a first aspect the invention relates to a container for kitchen and cooking utensils. The container is preferably heat-resistant, at least to a certain extent, to enable use on a stove, wherein the container is further configured for establishing, in operational use, a releasable connection between the container and a pan, such as a casserole or pot. The container comprises a releasable coupling for establishing the releasable connection between the container and the pan. The releasable coupling comprises a corner or hook for being hung over an edge of the pan in operational use.

The effects of the combination of the features of the invention are as follows. The container of the invention is configured for being coupled with the pan, i.e. being right next to, while it is being used on a stove, but also when it is being used on the table. Instead of putting the cooking utensils on the counter or on the table when not used, they may be conveniently stored in the container right next to the pan. In this way food spoiling, dirt and mess may be prevented. As the pan gets hot when used on a stove, the container must be heat resistant at least to a certain extent. When not used on a stove, for instance when used on the table, the heat resistance is not important. When the pan is to be stored in a cupboard, the container may be conveniently disconnected from the pan. It is advantageous to provide the container with the releasable coupling, such that the conventional pans and pots do not require modification. The container is conveniently coupled to the pan by simply hanging it on an edge of the pan. This constitutes a simple yet effective solution.

In an embodiment of the container of the invention the releasable coupling is height-adjustable to enable use with different heights of the pan. This embodiment enables a one-size-fits-all system. As pans may have different heights also the hook of a container may need to be provided at different heights. A similar problem occurs if the height of the container is significantly larger than the height of the pan. This will be further illustrated in the detailed description of the figures.

In an embodiment of the container in accordance with the invention the container is provided with an additional spacer at a lower end thereof in order to rest partially on the pan or casserole while hanging.

In an embodiment of the container in accordance with the invention the container is made of a plastic material, which is heat resistant, for example up to 150 degrees.

In an embodiment of the container in accordance with the invention the container is made of a heat resistant metal.

In a third aspect the invention relates to a cooking assembly comprising a pan and the container. It is not unlikely that the invention will be offered on the market as a set (or assembly) comprising one or more pans and one or more containers of the invention, such set or assembly being fully covered by the scope of the invention as claimed.

### BRIEF DESCRIPTION OF THE DRAWINGS

In the following is described an example of a preferred embodiment illustrated in the accompanying drawings, wherein:

FIG. 1 shows a first embodiment of the invention, and

FIG. 2 shows a second embodiment of the invention.

### DETAILED DESCRIPTION OF THE DRAWINGS

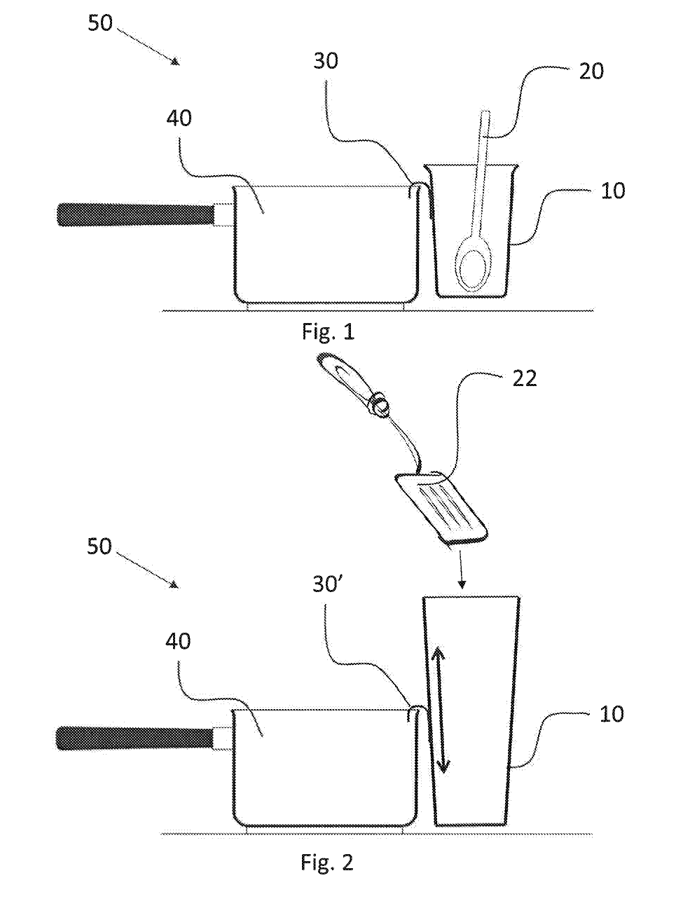

FIG. 1 shows a first embodiment of the invention. The figure shows a cooking assembly 50 comprising a casserole 40 and a container 10 connected to it. The container 10 is provided with a corner or hook 30, which is hung over the edge of the casserole 40. The container 10 comprises a ladle 20. The casserole 40 is an example of a pan that may be used on a stove, and the ladle 20 is an example of a cooking tool or kitchen utensil. The hook 30 is an example of a releasable coupling in accordance with the invention. The invention is not limited to these examples. It is not necessary that the container 10 rests on a surface like the pan 40, but this is also feasible.

FIG. 2 shows a second embodiment of the invention. This figure also shows a cooking assembly 50. This embodiment is particularly handy when the pan has a very limited height or when there is a variety of pans, each having different heights. The container is 10 in FIG. 2 has a releasable connection 30′ (here also a hook), which is also height adjustable (as illustrated by the arrow in FIG. 2) in that the container may fit different heights of the pan 40. By way of illustration this embodiment has been illustrated with a spatula (or slice) 22, which is another example of a cooking tool or kitchen utensil.

It must be stressed that in accordance with the invention the container 10 may have many different shapes, including somewhat flattened, oval shapes, or shapes which follow the curves of the pan or casserole 40. All such shapes fall within the scope of the invention as claimed. The container 10 may also be provided with an additional spacer (not shown) at a lower end thereof in order to rest partially on the pan or casserole 40 while hanging. In one embodiment the container 10 is made of a plastic material, which is heat resistant up to 150 degrees for example. Such heat resistance is generally enough to facilitate use on a stove. Alternatively, the container 10 may be made of a metal having a much higher heat resistance. In yet other applications, for instance when used on the table, a lower heat resistance, for instance up to 100 degrees, may suffice.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage. Throughout the Figures, similar or corresponding features are indicated by same reference numerals or labels.

1. A container for storing kitchen and cooking utensils 22) in an upright orientation, wherein the container is heat-resistant so as to enable use on a stove, wherein the container is further configured for establishing, in operational use, a releasable connection between the container and a pan, wherein the container comprises a releasable coupling for establishing the releasable connection between the container and the pan, wherein the releasable coupling comprises at least one of a corner and a hook for being hung over an edge of the pan in operational use.

2. The container according to claim 1, wherein the releasable coupling is height-adjustable to enable use with different heights of the pan.

3. The container according to claim 1, wherein the container is provided with an additional spacer at a lower end thereof in order to rest partially on the pan while hanging.

4. The container according to claim 1, wherein the container is made of a plastic material, which is heat resistant up to 150 degrees.

5. The container according to claim 1, wherein the container is made of a heat resistant metal.

6. A container for storing kitchen and cooking utensils in an up-right orientation, wherein the container is heat-resistant to enable use on a stove, wherein the container is further configured for establishing, in operational use, a releasable connection between the container and a pan, wherein the container comprises a releasable coupling for establishing the releasable connection between the container and the pan, wherein the releasable coupling is height-adjustable to enable use with different heights of the pan.

7. The container according to claim 6, wherein the releasable coupling comprises at least one of a corner and hook for being hung over an edge of the pan in operational use.

8. The container according to claim 6, wherein the container is provided with an additional spacer at a lower end thereof in order to rest partially on the pan while hanging.

9. The container according to claim 6, wherein the container is made of a plastic material, which is heat resistant up to 150 degrees.

10. The container according to claim 6, wherein the container is made of a heat resistant metal.

11. A cooking assembly comprising a pan and a container for storing kitchen and cooking utensils in an upright orientation, wherein the container is heat-resistant so as to enable use on a stove, wherein the container is further configured for establishing, in operational use, a releasable connection between the container and the pan, wherein the container comprises a releasable coupling for establishing the releasable connection between the container and the pan, wherein the releasable coupling comprises at least one of a corner and a hook for being hung over an edge of the pan in operational use,
